(19) United States
(12) Patent Application Publication
(10) Pub. No.: US 2007/0027033 A1
(43) Pub. Date: Feb. 1, 2007

(54) Anti-germination method of tubers or bulbs using eugenol and/or isoeugenol

(76) Inventor: Alberto Sardo, Chateaurenard (FR)

Correspondence Address: WENDEROTH, LIND & PONACK, L.L.P., 2033 K STREET N. W., SUITE 800, WASHINGTON, DC, 20006-1021, US

(21) Appl. No.: 11/541,706

(22) Filed: Oct. 3, 2006

(30) Foreign Application Priority Data
Apr. 10, 2005 (FR) 05 10140

(51) Int. Cl. A01N 25/26

(52) U.S. Cl. 504/348; 504/100

(57) ABSTRACT

The present invention relates to an anti-germination method for bulbs and tubers including the application to said bulbs or tubers of a treatment composition based on an active principle selected from eugenol, a salt of eugenol fit for human consumption, isoeugenol, a salt of isoeugenol fit for human consumption and mixtures thereof or clove oil, said method including the application by sprinkling, spraying or immersion at ambient temperature of said composition on the bulbs and tubers after storage.

### BACKGROUND OF THE INVENTION

The invention relates to an anti-germination method for tubers and bulbs, by application to said tubers and bulbs of a eugenol or isoeugenol-based treatment composition.

This method is particularly suitable for the treatment of onion bulbs and potato tubers.

Once potatoes or other tubers have been harvested, they are kept at temperatures of from approximately 20 to 30° C. for about ten days in order to harden their epidermal layer or “skin”, then gradually cooled to their preservation temperature of approximately 10° C., generally between 7 and 10° C.

During the first month or even the first two to three weeks after harvest, the tubers remain dormant and display little tendency to germination.

However, before the end of this period, the tubers have to be treated chemically in order to inhibit germination, which would have adverse effects such as a loss in fresh weight, preservation of starch in sugar, a reduction in the quality of tubers and deterioration of the appearance thereof.

In addition, both the sprouts and the neighbouring tissues contain high levels of toxic glycoalkaloids which are not destroyed during cooking.

It is crucial to delay germination, as germination has adverse effects such as the loss in fresh weight, the preservation of starch in sugar, the reduction in the quality of the tubers and bulbs and the deterioration of the appearance thereof.

Examples of bacterial strains which attack the tubers include Fusarium, Helminthosporium, Phoma, such as Phoma exiga.

A first anti-germinating treatment is normally carried out within 15 days, and no later than 30 days, following harvest.

The most commonly used anti-germinating treatment methods employ chemical agents such as chloropropham (CIPC, methyl ethyl-3-chlorophenyl carbonate). These chemical agents present the consumer with high risks of toxicity, so the approved doses are always being reduced.

When the tubers leave the cold room, it is normal for germination to start owing to the decline in the residues of the anti-germinating product during preservation and, above all, the exposure of the tubers to a more elevated temperature. It would be dangerous to treat the potatoes with a CIPC formulation at this stage, as this would boost the level of residues and pose a threat to consumers, even within the legally sanctioned limit.

It is therefore important to provide a product which is both sufficiently strong to destroy those sprouts that have already formed and less toxic than CIPC.

The use of terpenes in the anti-germinating treatment of tubers and bulbs has recently been proposed: the advantage of these terpenes is their non-toxicity. Thus, application WO 00/32054 relates to an anti-germinating treatment method consisting in applying to the tubers a eugenol or isoeugeonl composition when hot. Two methods of application are envisaged:
application of the temperature from 40 to 60° C. by immersion or showering;
application of the eugeonol-based composition by fogging, the temperature of the mist at the outlet of the apparatus being between 110 and 300° C.

The active principle content of the composition is between 80% and 100% or from 15% to 80%, preferably from 25 to 60%; preferably in combination with a surfactant and/or an agent reducing evaporation.

Nevertheless, the methods described in this application require the composition to be heated and can therefore be difficult to carry out.

Furthermore, the composition is basically used for preventive purposes, prior to the appearance of the sprouts and/or storage. The effect of eugenol on the sprouts that have already formed has not been established.

However, it has now been demonstrated that eugenol in emulsifiable liquid solution applied in line to washed potatoes or by immersion of the potatoes in a dilute aqueous solution, after storage of the potatoes at ambient temperature, served to prevent germination and to burn the nascent sprouts more effectively than the CIPC-based formulation or other essential oils applied in a similar manner.

The present application therefore relates to a post-storage anti-germination method for bulbs or tubers which is based on eugenol, isoeugenol or one of the salts thereof and is simpler to carry out.

### SUMMARY OF THE INVENTION

According to a first subject-matter, the present application therefore relates to an anti-germinating treatment method for bulbs or tubers including the application to said bulbs or tubers of a treatment composition based on eugenol, isoeugenol or one of the salts thereof fit for human consumption and mixtures thereof, or clove oil, said method including the application by sprinkling, spraying or immersion of said composition at ambient temperature on the bulbs and the tubers after storage.

The tubers are stored cold, as is conventional, especially at a temperature of approximately 10° C., preferably between 7 and 10° C. The storage period generally lasts a plurality of months, preferably from 5 to 7 months.

The bulbs and tubers are treated after their preservation period, before they are sold, preferably once they have been cleaned. This post-storage treatment, on leaving the cold rooms, is particularly advantageous.

According to a first aspect, the active principle is clove oil.

According to a second aspect, the active principle is eugenol.

According to another aspect, the active principle is a salt of eugenol or isoeugenol fit for human consumption. Salts fit for human consumption may, in particular, be alkali metal salts such as sodium salts, lithium salts or potassium salts. A treatment of this type by a composition based on a salt of eugenol or isoeugenol fit for human consumption is particularly advantageous. The use of a partially or completely salified composition allows the strong, unpleasant odour of eugenol and isoeugenol to be partially or entirely eliminated.

According to another preferred aspect, said composition contains completely or partially salified clove oil. In this case, a salt fit for human consumption (for example, sodium salt, lithium salt, potassium salt) is introduced into the composition, during preparation thereof, in salt form or else in neutral form; in this latter case, the salt is formed in situ by the addition of a suitable base such as an alkali metal hydroxide (for example, sodium hydroxide or potassium hydroxide). The degree of salification of the partially salified clove oil is preferably greater than or equal to 40%, 50%, 75%, 90% or 99%.

According to another aspect, the treatment composition may be applied continuously or repeatedly over time.

According to another preferential aspect, said composition comprises, prior to optional dilution, from 15% to 40% of active principle; more preferably, approximately 25% of active principle, for example of clove oil. According to another preferred aspect, said composition comprises, prior to optional dilution, from 60% to 85% of emulsifiers, more preferably approximately 75% of emulsifiers.

According to a particular aspect, said emulsifiers comprise condensation products from fatty acids and/or alcohols; more preferably the emulsifiers are selected from among ethoxylated lauryl alcohol, ethoxylated oleic acid and/or mixtures thereof. As lecithin has a safening effect, emulsifiers which do not contain lecithins are preferred.

According to another subject-matter, the present invention also relates to a composition comprising from 15% to 40% of eugenol, isoeugenol or one of the salts thereof fit for human consumption, or mixtures thereof, or clove oil, and from 60% to 85% of emulsifiers. Preferably, said composition comprises approximately 25% of clove oil and from 70% to 80% of emulsifiers, more preferably approximately 75% of emulsifiers.

According to a particular aspect of the invention, said emulsifiers are composed of from 10 to 40% of condensation products from lauryl alcohol and of from 50% to 90% of condensation products from oleic acid and/or mixtures thereof.

According to a more particular aspect, said emulsifiers are composed of from 10% to 40% of ethoxylated lauryl alcohol 11 mol and from 50% to 90% of ethoxylated oleic acid 6 mol and ethoxylated oleic acid 10 mol and/or mixtures thereof.

According to a more particular aspect, the composition, comprising one or more emulsifiers as described above, contains eugenol and/or isoeugenol and/or clove oil as the anti-germinating compound.

The salt-based or salified compositions according to the invention obviate the need for surfactants.

A partially salified clove oil composition is particularly advantageous. Preferably, the degree of salification of a “partially salified” clove oil is greater than or equal to 40%, greater than or equal to 50%, greater than or equal to 75%, greater than or equal to 90% or greater than or equal to 99%.

For example, a composition of this type is prepared by mixing 26% of clove oil and 2.25% of base, for example KOH, in water. According to another subject-matter, the present invention relates to the use of said composition for sprinkling, spraying or immersion on bulbs and/or tubers at ambient temperature for anti-germinating purposes.

The term “anti-germination” in the present context designates preventive treatment preventing the formation of sprouts and treatment effectively destroying those sprouts that have already formed. The destruction of the sprouts that have already formed is a preferred aspect of the present invention.

According to a preferred aspect of the invention, the composition is used on bulbs and/or tubers, for example potatoes, after storage, as defined hereinbefore.

The treatment composition can be applied to the bulbs and tubers using any one of the methods known in the art, for example sprinkling or spraying. The specific content of the compositions according to the invention eliminates the need to heat the composition, which may have an adverse effect if it is applied to the bulbs and tubers when hot. The composition therefore also eliminates the need for the subsequent cooling step which may otherwise be necessary.

Moreover, the specific content of the compositions according to the invention makes the treatment composition particularly easily dispersible in water. This is particularly advantageous if the composition is applied after the bulbs and tubers have been washed. The treatment composition is thus dispersed in the film of water coating the bulbs and tubers after washing. Homogeneous coverage, and therefore effective penetration of the bulb or tuber, thus ensues.

The salified or partially salified compositions according to the invention also obviate the need for surfactants.

The compositions according to the invention may be used in pure form or dispersed in water. The term “compositions according to the invention” also refers to compositions diluted in water. Generally, the dilute compositions have a concentration of between 2 and 50%, preferably between 5 and 10%.

Generally, the amount of water is adjusted in such a way that the final active principle content of the treatment composition is between 500 and 30,000 ppm by weight, better still between 1,000 and 20,000 ppm by weight.

The treatment composition is prepared, in a manner conventional per se, by the mere mixing of its constituents.

If the treatment composition comprises a salt fit for human consumption, said salt may be introduced into the composition, during preparation thereof, in salt form or else in neutral form; in this latter case, the salt is formed in situ by the addition of a suitable base such as an alkali metal hydroxide (sodium hydroxide or potassium hydroxide).

Generally, 200 g of composition is applied per tonne of treated tuber or bulb.

More generally, the applied amount of composition is adjusted as a function of the storage time and/or the time between leaving the cold room in which said composition is stored and being sold. As eugenol and isoeugenol are odorants, it is preferable that, when they are sold, almost all of the active principle has evaporated in order not to alter the commercial value of the bulbs and tubers. The amount of active principle to be applied therefore depends on the nature and the volatility of the active principle used. Eugenol and isoeugenol in the form of a salt fit for human consumption or completely or partially salified clove oil are particularly advantageous owing to their less strong odour.

### DETAILED DESCRIPTION OF THE INVENTION

The following examples illustrate the invention in greater depth.

### EXAMPLE 1

The following formulation was used for the immersion of potatoes:
25% of clove oil, and
75% of emulsifiers consisting of:
   47% of ethoxylated oleic acid 6 mol;
   9% of ethoxylated oleic acid 10 mol;
   19% of ethoxylated lauryl alcohol 11 mol.

### EXAMPLE 2

The following formulation was used for the immersion of potatoes:
20% of eugenol;
80% emulsifiers consisting of:
   50% of ethoxylated oleic acid 6 mol;
   10% of ethoxylated oleic acid 10 mol;
   20% of ethoxylated lauryl alcohol 11 mol.

### EXAMPLE 3

Potatoes of the Russet Burbank and Russet Norkotah varieties were washed, stored in a cold room for approximately six months, then taken out. Tubers having sprouts visible to the naked eye were set aside.

The formulations of Examples 1 and 2 were diluted in water at a concentration of 5% (Example 1) or 4% (Example 2) and the potatoes were subsequently immersed in the solution for 5 seconds, then left to dry at ambient temperature.

The following results were obtained.

Measurements were taken 24 hours and 48 hours after treatment, based on the following scale:

1: no effect on the sprouts

2: destruction of 25% of the sprouts on the tubers

3: destruction of 50% of the sprouts on the tubers

4: destruction of 75% of the sprouts on the tubers

5. destruction of 100% of the sprouts on the tubers

The following results were obtained

i) Russet Burbank

| | 24 hours | 48 hours |
|---|---|---|
| Control | 1.0 | 1.0 |
| Composition 1 | 4.8 | 5.0 |
| Composition 2 | 4.8 | 5.0 |

ii) Russet Norkotah

| | 24 hours | 48 hours |
|---|---|---|
| Control | 1.0 | 1.0 |
| Composition 1 | 5.0 | 5.0 |
| Composition 2 | 5.0 | 5.0 |

1. An anti-germination method for bulbs and tubers including the application to said bulbs or tubers of a treatment composition based on an active principle selected from eugenol, a salt of eugenol fit for human consumption, isoeugenol, a salt of isoeugenol fit for human consumption and mixtures thereof or clove oil, said method including the application by sprinkling, spraying or immersion at ambient temperature of said composition on the bulbs and tubers after storage.

2. A treatment method according to claim 1, wherein the method includes the step of subjecting said bulbs and tubers to treatment by sprinkling or spraying with said treatment composition or by immersion in said treatment composition, after storage of the bulbs and tubers.

3. A treatment method according to claim 1, wherein the active principle is clove oil.

4. A treatment method according to claim 3, wherein said clove oil is completely or partially salified.

5. A treatment method according to claim 1, wherein the active principle is eugenol, a salt of eugenol fit for human consumption, and mixtures thereof.

6. A treatment method according to claim 1, wherein the treatment composition is applied continuously or repeatedly to said bulbs and tubers.

7. A treatment method according to claim 1, wherein said composition prior to optional dilution comprises from 15 to 40% of active principle.

8. A method according to claim 7, wherein the composition comprises, prior to optional dilution, 25% of clove oil.

9. A method according to claim 1, wherein said composition comprises, prior to optional dilution, from 60 to 85% of emulsifiers.

10. A method according to claim 1, wherein said composition comprises, prior to optional dilution, 75% of emulsifiers.

11. A method according to claim 9, wherein said emulsifiers comprise condensation products with fatty alcohols and/or acids.

12. A method according to claim 11, wherein said emulsifiers comprise ethoxylated lauryl alcohol, ethoxylated oleic acid and/or mixtures thereof.

13. A method according to claim 1, wherein the tubers are potato tubers.

14. A composition comprising:
from 15 to 40% of eugenol, a salt of eugenol fit for human consumption, isoeugenol, a salt of isoeugenol fit for human consumption and mixtures thereof or clove oil,
from 60 to 85% of emulsifiers.

15. A composition according to claim 14, wherein the composition comprises 25% of clove oil.

16. A composition according to claim 14, wherein the composition comprises from 70 to 80% of emulsifiers.

17. A composition according to claim 14, wherein the composition comprises 75% of emulsifiers.

18. A composition according to claim 14, wherein said emulsifiers comprise condensation products from fatty alcohols and/or acids.

19. A composition according to claim 18, wherein said emulsifiers comprise ethoxylated lauryl alcohol, ethoxylated oleic acid and/or mixtures thereof.

20. A composition according to claim 19, such that said emulsifiers are selected from among ethoxylated lauryl alcohol 11 mol, ethoxylated oleic acid 6 mol and ethoxylated oleic acid 10 mol and/or mixtures thereof.

21. A composition according to claim 14, such that said emulsifiers are composed of:
from 10 to 40% of condensation products from lauryl alcohol, and
from 50 to 90% of condensation products from oleic acid and oleic acid and/or mixtures thereof.

22. A composition according to claim 14, such that said emulsifiers are composed of:
from 10 to 40% of ethoxylated lauryl alcohol 11 mol, and
from 50 to 90% of ethoxylated oleic acid 6 mol and ethoxylated oleic acid 10 mol and/or mixtures thereof.

23. A composition diluted with a composition according to claim 14 at a level of from 2% to 50%.

24. Use of a composition according to claim 23 for sprinkling, spraying or immersion on bulbs and/or tubers at ambient temperature for anti-germinating purposes.
